(19) United States
(12) Patent Application Publication
(10) Pub. No.: US 2016/0362911 A1
(43) Pub. Date: Dec. 15, 2016

(54) Swing Bolt Lock Sleeve

(71) Applicant: Hotel Solutions Inc., Mount Freedom, NJ (US)

(72) Inventor: Morgan Sussman, Randolph, NJ (US)

(21) Appl. No.: 15/180,960

(22) Filed: Jun. 13, 2016

Related U.S. Application Data
(60) Provisional application No. 62/175,168, filed on Jun. 12, 2015.

(51) Int. Cl. E05B 17/00; E05F 5/02; E05C 17/16

(52) U.S. Cl. CPC E05B 17/0041; E05C 17/166; E05B 17/0045; E05F 5/02

(57) ABSTRACT

Exemplary embodiments of the current invention disclose an improved device for covering a swing bolt arm. The swing bolt lock sleeve comprises a sleeve having a first end extending to a second end and a wall of a first width bounding a hollow interior extending therethrough, permitting slidable engagement of swing bolt arms to contain the swing bolt therein. The swing bolt lock sleeve is composed of impact absorbing material for dampening impact between a door and door frame with the interposed swing bolt sleeve covered swing bolt. The swing bolt sleeve includes at least one bumper disposed along the length of the swing bolt lock sleeve, the bumper being defined by a section wherein the wall thickness flares outwardly.

### CROSS-REFERENCE

This application claims priority to U.S. Provisional Patent Application No. 62/175,168 filed Jun. 12, 2015 entitled “U BOLT DOOR PROTECTOR”

### BACKGROUND

Field

The present invention relates to security and, more specifically, to a device for covering a swing bolt security latch.

Description of Related Art

For security, some room doors, such as offices or hotel rooms, are equipped with swing bolt locks, frequently in addition to other locks. The swing bolt locks are provided for use by the room occupant from inside the room. The swing bolt locks are typically made of high strength rigid material such as metals. The swing bolt side is typically mounted to the door frame and the corresponding catch is mounted to the door. When engaged, the swing radius of the door is restricted to the length of the channel of the swing bolt, thwarting entrants.

However, at times, swing bolt locks are used to intentionally keep the hotel door from closing. The swing bolt arm is swung over between the door frame and the door without engaging the catch so that the swing bolt arm is interposed between the door and door frame, thus it cannot pivot to the closed position where other door locks would engage. When the occupant does this, he releases the door to close it or allow it to close, the door directly impacts the swing bolt arm, making noise and damaging the door and door frame over time. It would be desirable to minimize this impact.

### SUMMARY

Exemplary embodiments of the current invention disclose a device for covering a swing bolt. The swing bolt lock sleeve comprises a sleeve having a first end extending to a second end and a wall of a first width bounding a hollow interior extending therethrough, permitting slidable engagement of swing bolt arms to contain the swing bolt therein. The swing bolt lock sleeve is composed of impact absorbing material for dampening impact between a door and door frame with the interposed swing bolt sleeve covered swing bolt. The swing bolt sleeve includes at least one bumper disposed along the length of the swing bolt lock sleeve, the bumper being defined by a section wherein the wall thickness flares outwardly.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description. Various example embodiments of the present invention are discussed in detail below with reference to the accompanying drawings, in which example embodiments of the present invention are shown. While specific implementations are discussed, this is done for illustration purposes only. A person of ordinary skill in the relevant art will recognize that other components and configurations maybe used without departing from the spirit and scope the present invention. Like numbers refer to like elements throughout.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1 depicts a top view of an embodiment of a swing bolt lock sleeve according to the current invention.

FIG. 2 depicts a top view of an embodiment of a swing bolt lock sleeve according to the current invention.

FIG. 3 depicts a front view of an embodiment of a swing bolt lock sleeve according to the current invention.

FIG. 4 depicts a side perspective view of an embodiment of a swing bolt lock sleeve according to the current invention.

FIG. 5 depicts a side perspective view of an embodiment of a swing bolt lock sleeve according to the current invention as it may exist in operation.

FIG. 6 depicts a side view of an embodiment of a swing bolt lock sleeve according to the current invention as it may exist in operation.

### DESCRIPTION

It is contemplated that any embodiment of a method or composition described herein can be implemented with respect to any other method or composition described herein.

The use of the word “a” or “an” when used in conjunction with the term “comprising” in the claims and/or the specification may mean “one,” but it is also consistent with the meaning of “one or more,” “at least one,” and “one or more than one.”

The use of the term “or” in the claims is used to mean “and/or” unless explicitly indicated to refer to alternatives only or the alternative are mutually exclusive, although the disclosure supports a definition that refers to only alternatives and “and/or.”

Throughout this application, the term “about” is used to indicate that a value includes the standard deviation of error for the device or method being employed to determine the value.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description. Various example embodiments of the present invention are discussed in detail below with reference to the accompanying drawings, in which example embodiments of the present invention are shown. While specific implementations are discussed, this is done for illustration purposes only. A person of ordinary skill in the relevant art will recognize that other components and configurations maybe used without departing from the spirit and scope the present invention. Like numbers refer to like elements throughout.

A common swing bolt 04 is “U” shaped and made of high strength rigid material such as metal. The U shape swing bolt is commonly made of a continuous piece of metal or other durable, rigid, and strong material with a ˜180° curve in its middle segment. The U shaped swing bolt includes first and second parallel arms having a substantially circular or ovular cross-section of a width w. The legs are joined at the curve and are separated by a predetermined distance, with the spacing presenting a slide channel for a catch. A section of the slide channel widens at the end distal to the curve in order to enable insertion of the catch. The catch includes an arm segment, having a width less than the slide channel, and a protrusion wider than the slide channel. In common use, the swing bolt 04 is pivotally mounted to a door frame 06 and the catch mounted to the door 08.

In operation, the swing bolt 04 allows the door to be swung open approximately a distance that corresponds to the length of the slide channel. The receiving hole of the pivoting U-shaped swing bolt serves as an unlocking portion of the U-shaped swing bolt. The narrower configuration or width of the slide channel serves as a locking portion of the pivoting U-shaped swing bolt 04.

According to exemplary embodiments, the swing bolt lock sleeve 10 is configured to conform to the exterior surface of a swing bolt 04. The swing bolt lock sleeve 10 is slidably engaged to the swing bolt 04. The swing bolt lock sleeve 10 provides a barrier between the swing bolt 04 and the door 08, providing impact absorption to dampen impact forces applied thereto.

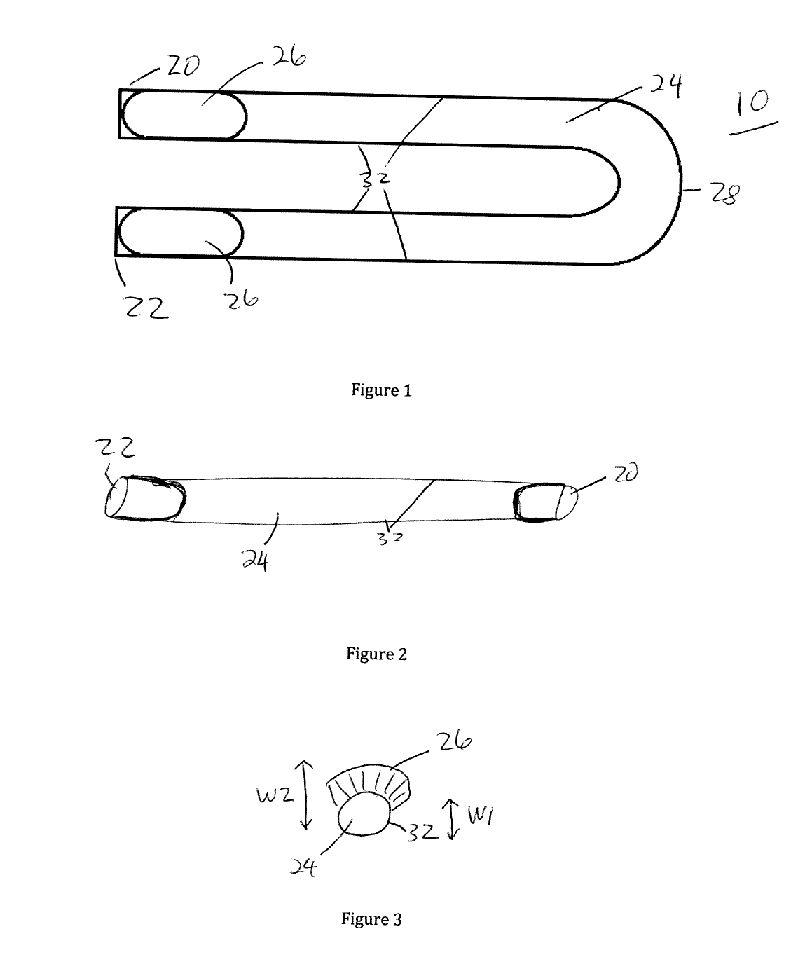

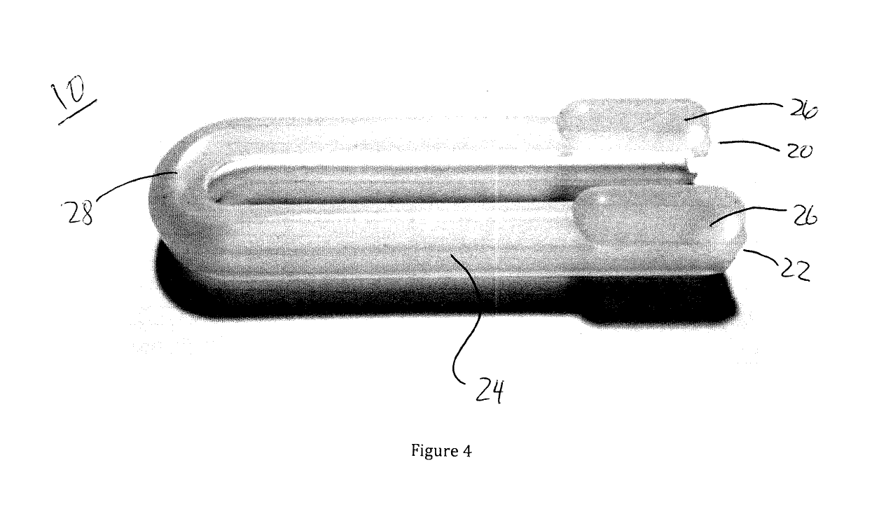

FIG. 1 depicts a top view of an embodiment of a swing bolt lock sleeve 10. The swing bolt lock sleeve 10 includes a first end 20, a second end 22, and a hollow interior 24. In exemplary configuration, the device 10 is unitary. The swing bolt lock sleeve 10 encompasses a major portion of or all of the swing bolt 04. In exemplary configuration, the swing bolt lock sleeve 10 is frictionally secured to the exterior of the swing bolt 04 by elasticity or a textured surface so that, after engagement, the swing bolt lock sleeve 10 remains securely in position relative to the swing bolt 04. In other configurations, an adhesive secures the relative position of the device 10.

As shown in FIGS. 1-3, the swing bolt lock sleeve 10 has a first end 20 extending to a second end 22 and a hollow interior 24 extending therethrough, permitting slidable engagement of the swing bolt 04 in order to encompass the swing bolt 04 arms. The cross-sectional profile of the hollow interior 24 is shaped to closely conform to the target swing bolt 04, with the walls 32 abutting the swing bolt 04 exterior surface. Example cross-sectional profiles include circular, ovular, and others known in the art. The hollow interior 24 has a width W1.

A further exemplary device 10 is snugly fitted to the contoured configuration of the swing bolt 04 so that the swing bolt lock sleeve 10 under users' normal manipulation of the swing arm bolt 04. For example, the fitting of the swing bolt lock sleeve 10 could adhere to the surface of the swing bolt 04 depending on shape and friction, or other means to effectuate attachment. For example, FIG. 2 illustrates a linear swing bolt lock sleeve 10, while FIG. 1 illustrates a pre-shaped swing bolt lock sleeve 10 having an inline curve section 28 biasing the device 10 towards the curved shape, the curve section 28 providing additional frictional resistance to sliding along the swing bolt 04.

As disclosed above, it is an object of this invention to dampen noise and damage of doors 08 and door frames 06 with swing bolt 04, where the swing bolt 04 is used to intentionally keep the door from closing in order to keep the door 08 from engaging the other locks. The swing bolt 04 is swung over between the door frame 06 and the door 08 without engaging the catch so that the swing bolt 04 is interposed between the door and door frame. Depending on the channel length, the mount point of the swing bolt 04 on the door frame 06, and other factors, there are higher probability impact zones where the door would impact the swing bolt 04 and varying impact forces. FIG. 3 illustrates an embodiment of the device 10 having a bumper 26, where the wall 32 thickness flares outwardly. Certain embodiments of the device 10 include one or more bumpers 26 disposed along its length. The bumpers 26 are sections of the device 10 where the wall 32 thickness is expanded for greater impact dampening. For instance, the wall thickness may be several multiples of the thickness of the wall 32 section. Exemplary embodiments include a first bumper 26 disposed at the first end 20 and a second bumper 26 disposed at the second end 22, each bumper being continuous and unitary with the wall 32 and radially expanding outward.

The exemplary swing bolt lock sleeve 10 is composed of elastic, impact absorbing material operable to snugly fit the swing bolt 04, to protect a door's 08 surface, protect a door frame 06, and/or minimize vibration and noise of when the device 10 is repeatedly impacted by a door 08. Representative exemplary suitable materials include rubbers, soft plastics, silicones, other similar natural or synthetic products, and combinations thereof.

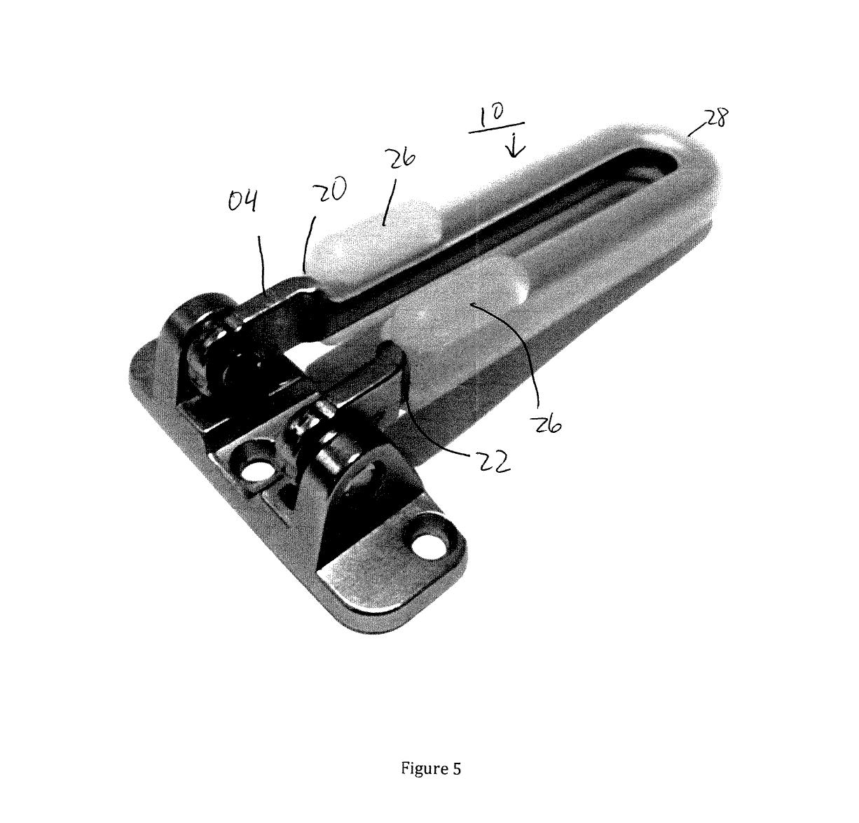

FIG. 5 illustrates operation of the swing bolt lock sleeve 10. The device is slidably engaged over engaged to a swing bolt arm. A first arm of the swing bolt 04 is introduced to the first end 20 of the device 10. The first arm is slidably introduced to the hollow interior 24 of the device 10. The device 10 is further slidably engaged until it covers the majority of the swing bolt 04.

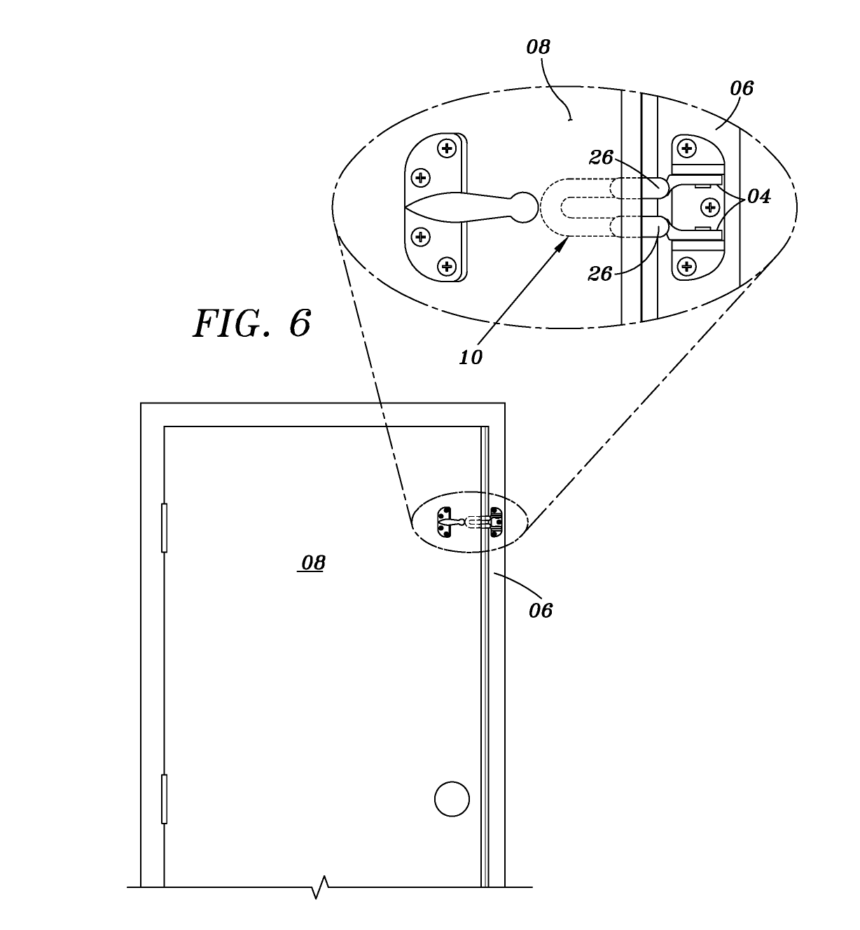

FIG. 6 illustrates further operation of the swing bolt lock sleeve 10. Illustrated is a swing bolt 04 covered by a swing bolt lock sleeve 10. The covered swing bolt 04 10 is mounted to the door frame 06, where is capable of being moved from operative to non-operative positions and other intermediary positions in between. The door 08 is shown closed and is viewed from the inside with the covered swing bolt 04 10 interposed and in contact with both the door 08 and door frame 06, in a non-operative position, thus the door 08 cannot pivot to the fully closed position. The covered swing bolt 04 10 dampens the initial impact and further frictional contact.

While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the present invention.

We claim:

1. A swing bolt lock sleeve comprising:
a. a first end extending to a second end and a wall of a first width bounding a hollow interior extending therethrough, permitting slidable engagement of a swing bolt;
b. said swing bolt lock sleeve composed of impact absorbing material;
c. a bumper disposed along the length of said swing bolt lock sleeve, said bumper defined by a section wherein said wall thickness flares outwardly.

2. The swing bolt lock sleeve of claim 1, wherein said bumper is disposed proximate said first end of said swing bolt sleeve.

3. The swing bolt lock sleeve of claim 1, further comprising a second bumper, said second bumper disposed along the length of said swing bolt lock sleeve.

4. The swing bolt lock sleeve of claim 2, further comprising a second bumper said second bumper disposed proximate said second end of said swing bolt sleeve.

5. The swing bolt lock sleeve of claim 1, wherein swing bolt lock sleeve is U-shaped.

6. The swing bolt lock sleeve of claim 1, wherein swing bolt lock sleeve is linear.

7. The swing bolt lock sleeve of claim 1, wherein the swing bolt lock sleeve has a unitary structure.

8. The swing bolt lock sleeve of claim 1, wherein said impact absorbing material is selected from the group consisting of rubber, plastic and silicone, or combinations thereof.

9. A swing bolt lock sleeve comprising:
a. a first end extending to a second end and a wall of a first width bounding a hollow interior extending therethrough, permitting slidable engagement of a swing bolt;
b. said swing bolt lock sleeve composed of impact absorbing material;
c. a bumper disposed along the length of said swing bolt lock sleeve, said bumper defined by a section wherein said wall thickness flares outwardly, said bumper disposed proximate said first end of said swing bolt sleeve.

10. The swing bolt lock sleeve of claim 9, further comprising a second bumper said second bumper disposed proximate said second end of said swing bolt sleeve.

11. The swing bolt lock sleeve of claim 10, wherein swing bolt lock sleeve is U-shaped.

12. The swing bolt lock sleeve of claim 10, wherein swing bolt lock sleeve is linear.

13. The swing bolt lock sleeve of claim 10, wherein the swing bolt lock sleeve has a unitary structure.

14. The swing bolt lock sleeve of claim 9, wherein said impact absorbing material is selected from the group consisting of rubber, plastic, and silicone, or combinations thereof.

15. A swing bolt lock system comprising:
a. a swing bolt lock and a swing bolt lock sleeve;
b. said swing bolt lock sleeve comprising:
i. a first end extending to a second end and a wall of a first width bounding a hollow interior extending therethrough, permitting slidable engagement of a swing bolt;
ii. said swing bolt lock sleeve composed of impact absorbing material;
iii. a bumper disposed along the length of said swing bolt lock sleeve, said bumper defined by a section wherein said wall thickness flares outwardly, said bumper disposed proximate said first end of said swing bolt sleeve.

16. The swing bolt lock system of claim 15, further comprising a second bumper said second bumper disposed proximate said second end of said swing bolt sleeve.

17. The swing bolt lock system of claim 15, wherein swing bolt lock sleeve is U-shaped.

18. The swing bolt lock system of claim 15, wherein swing bolt lock sleeve is linear.

19. The swing bolt lock system of claim 15, wherein the swing bolt lock sleeve has a unitary structure.

20. The swing bolt lock system of claim 15, wherein said impact absorbing material is selected from the group consisting of rubber, plastic and silicone, or combinations thereof.
